(19) United States
(12) Patent Application Publication
(10) Pub. No.: US 2025/0102027 A1
(43) Pub. Date: Mar. 27, 2025

(54) BICYCLE DISK BRAKE PAD AND METHOD FOR MAKING THE SAME

(71) Applicant: Huang-Chieh Metal Composite Material Tech. Co., Ltd., New Taipei City (TW)

(72) Inventor: Chin-Han Wang, New Taipei City (TW)

(21) Appl. No.: 18/372,790

(22) Filed: Sep. 26, 2023

(51) Int. Cl. F16D 65/092; F16D 69/04

(52) U.S. Cl. CPC F16D 65/092; F16D 2069/0466

(57) ABSTRACT

A bicycle disk brake pad and a method for making the same are provided. The bicycle disk brake pad includes a heat dissipation member and a friction member provided with a stainless steel substrate and a friction pad attached to the substrate by sintering. The heat dissipation member is made of aluminum alloy-stainless steel clad metal plate while a joined plate of the heat dissipation member is directly formed by stainless steel sheet of the aluminum alloy-stainless steel clad metal plate. Then the substrate and the joined plate are connected by laser welding. The substrate of the friction member and the joined plate of the heat dissipation member both made of stainless steel prevent the disk brake pad from deformation at high temperature due to reliable structural strength provided by the stainless steel. Aluminum alloy with excellent thermal conductivity helps dissipate heat from the disk brake pad more effectively.

### FIELD OF THE INVENTION

The present invention relates to a bicycle disk brake, especially to a bicycle disk brake pad and a method for making the same.

### BACKGROUND OF THE INVENTION

Brake pads are important components of a disc brake. The performance of the brake pad is critical to driving safety. In order to prevent brake failure resulted from brake pad fade caused by high temperature, people in the business have developed a brake pad with self-heat-dissipation effect which not only provides higher heat dissipation but also avoids problems of the brake pad caused by high temperature.

The brake pad with self-heat-dissipation effect is formed by a metal plate assembled with a friction piece. High heat of the friction piece is removed by the metal plate with good thermal conductivity. In order to enhance heat dissipation capacity of the brake pad, basically an area of the metal plate of the brake pad with self-heat-dissipation effect needs to be increased.

Refer to Taiwanese Pat. No. 1607923, a bicycle brake pad which includes a cooling plate and a friction pad is provided. The cooling plate has a first surface, a second surface, a pad supporting section and a heat dissipation section. The friction pad is mechanically and fixedly connected to the pad supporting section of the cooling plate. The friction pad fits into a recess on the first surface. The recess includes a pair of apertures. A base portion of the friction pad includes a pair of rivet portions. During assembly of the friction pad with the cooling plate, the rivet portions are inserted through the apertures. Then the rivet portions are deformed to form deformed heads which fill the recesses for mechanically fixing and connecting the friction pad to the pad supporting section of the cooling plate.

The base portion of the friction pad mentioned in the above Taiwanese Pat. No. 1607923 is made of a metallic material such as brass, aluminum, steel alloy or other metallic materials that provide good heat transferring properties. In practice, these metallic materials have certain problems. Compared with steel alloy, brass and aluminum have lower mechanical strength and easy deformation due to high temperature generated during operation of the friction pad. If the base portion of the friction pad is made of steel alloy, deformation of the rivet portions into deformed heads after being inserted through the apertures will be quite difficult.

Refer to Chinese Pat. Pub. No CN102312947A, a bicycle brake pad is provided. A cooling plate is made of metal and provided with a friction plate. The cooling plate includes a plurality of heat dissipating fins for increasing heat dissipating area of the cooling plate. The heat dissipating fins and the cooling plate are integrated into one part and made of the same metallic material. Also refer to Taiwanese Pat. No. M445652 “One-piece heat dissipation brake pad structure”, and Chinese Pat. Pub. No. CN203756816U “replaceable heat dissipation brake pad”, they also have similar designs. However, the above prior arts use a single metallic material (such as aluminum). Although good thermal conductivity is provided, the aluminum or aluminum alloy is easy to have deformation due to high temperature and unable to provide sufficient structural strength to the brake pad.

### SUMMARY

Therefore, it is a primary object of the present invention to provide a bicycle disk brake pad and a method for making the same which provide not only sufficient structural strength to avoid deformation of the disk brake pad at high temperature but also excellent heat dissipation effect.

In order to achieve the above object, a bicycle disk brake pad according to the present invention includes a heat dissipation member and a friction member. The heat dissipation member is made of aluminum alloy-stainless steel clad metal plate formed by an aluminum alloy sheet and a stainless steel sheet attached to one lateral surface of the aluminum alloy sheet. The heat dissipation member consists of a first surface and a second surface on two opposite sides of the heat dissipation member, a heat dissipating area, a joined area, a plurality of heat dissipation fins on the first surface of the heat dissipating area, and a joined plate disposed on the joined area. The plurality of heat dissipation fins is extending toward a direction away from the heat dissipation member while the joined plate is made of the stainless steel sheet of the aluminum alloy-stainless steel clad metal plate. An exposed surface of the joined plate is a joined surface which is flush with the second surface. The friction member is fixed on the joined surface of the joined plate and composed of a substrate and a friction pad respectively made of stainless steel and composite friction materials. The friction pad is formed and attached to the substrate by sintering of the composite friction material. The friction pad and the substrate are connected and integrated into one part. One lateral surface of the substrate without attached with the friction pad is adhered to the joined surface of the joined plate. A periphery of the substrate of the friction member and the joined surface of the joined plate are welded together by laser welding.

Preferably, the joined surface of the joined plate is provided with at least one blind hole while the lateral surface of the substrate of the friction member without attached with the friction pad is provided with at least one protrusion corresponding to the blind hole. The protrusion and the blind hole are coupled with each other correspondingly.

Preferably, a diameter of the blind hole is tapered inward to form the blind hole with a conical wall while a shape of the protrusion is conical which matches the conical wall of the blind hole.

Preferably, the joined surface of the joined plate is provided with two blind holes and two corresponding protrusions.

A method for making a bicycle disk brake pad according to the present invention includes the following steps.
a. preparing an aluminum alloy-stainless steel clad metal plate which is formed by a stainless steel sheet and an aluminum alloy sheet stacked over each other after surface cleaning and then treated by roll forming;
b. preparing a friction member by using stainless steel selected to produce a substrate, coating composite friction material over a lateral surface of the substrate to form a preset shape, and then sintering the composite friction material to form a friction pad attached to the substrate;
c. using the aluminum alloy-stainless steel clad metal plate to produce a heat dissipation member which includes a first surface and a second surface arranged at two opposite sides of the heat dissipation member, a heat dissipating area, a joined area, a plurality of heat dissipation fins disposed on the first surface of the heat dissipation area and extending toward a direction away from the heat dissipation member, and a joined plate which is disposed on the joined area, made of the stainless steel sheet of the aluminum alloy-stainless steel clad metal plate, and provided with an exposed surface to form a joined surface at the same level with the second surface; and
d. connecting the heat dissipation member with the friction member; connecting the substrate of the friction member and the joined plate at the joined area by laser welding.

Preferably, the step of preparing an aluminum alloy-stainless steel clad metal plate further includes a step of arranging the stainless steel sheet along a center line in a longitudinal direction of the aluminum alloy sheet of the aluminum alloy-stainless steel clad metal plate. A width of the stainless steel sheet perpendicular to the longitudinal direction is at least twice of a height of the friction member.

The bicycle disk brake pad features on that the substrate of the friction member and the joined plate of the heat dissipation member are both made of stainless steel to prevent the friction member from deformation at high temperature, Moreover, the heat dissipation member of the bicycle disk brake pad is made of the aluminum alloy-stainless steel clad metal plate. The stainless steel provides reliable structural strength so that the disk brake pad will not be deformed at high temperature during working period in which the friction member and the disk brake pad have friction therebetween while the aluminum alloy with excellent thermal conductivity makes the brake disk pad have good heat dissipation.

### BRIEF DESCRIPTION OF THE DRAWINGS

FIG. 1 is a perspective view of an embodiment of a bicycle disk brake pad according to the present invention;

FIG. 2 is a side view of a section of the embodiment in FIG. 1 according to the present invention;

FIG. 3 is an exploded view of the embodiment in FIG. 1 according to the present invention;

FIG. 4 is an exploded view of another embodiment according to the present invention;

FIG. 5 is a side view of a section of the embodiment in FIG. 4 according to the present invention;

FIG. 6 is a perspective view of an embodiment showing heat dissipation fins of a heat dissipation member according to the present invention;

FIG. 7 is a schematic drawing showing structure of an aluminum alloy-stainless steel clad metal plate of an embodiment of a method of making a bicycle disk brake pad according to the present invention;

FIG. 8 is a schematic drawing showing structure of an aluminum alloy-stainless steel clad metal plate of another embodiment of a method of making a bicycle disk brake pad according to the present invention.

### DETAILED DESCRIPTION

In order to learn features and advantages of the present invention more clearly, please refer to the following embodiments and detailed descriptions. However, the following embodiments are only intended for purposes of illustration and are not intended to limit the scope of the invention.

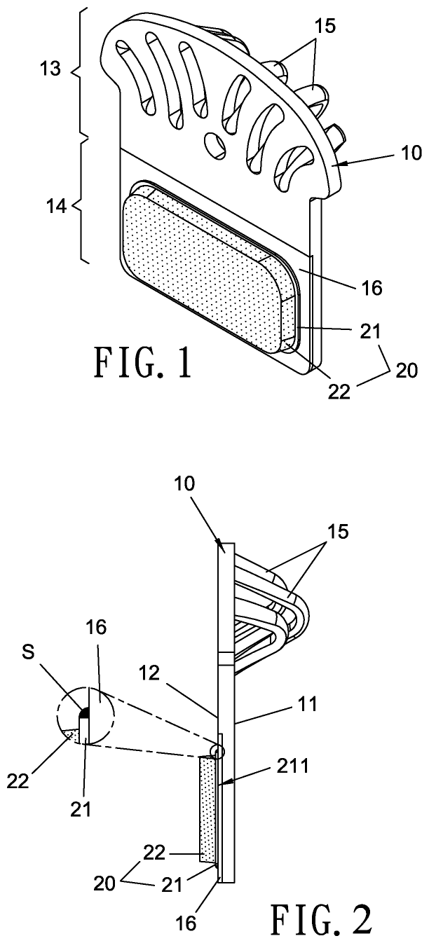

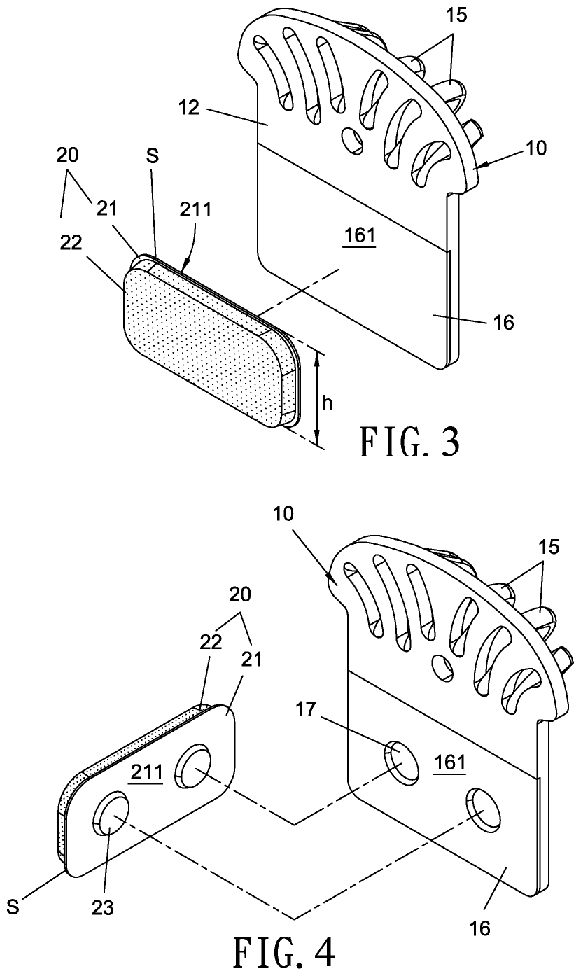

Refer to FIG. 1, FIG. 2, and FIG. 3, a preferred embodiment of a bicycle disk brake pad according to the present invention includes a heat dissipation member 10 and a friction member 20.

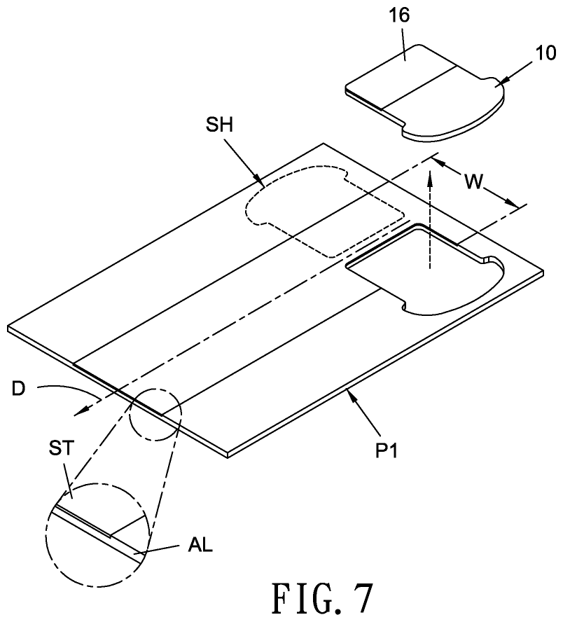

In a preferred embodiment, the heat dissipation member 10 is made of aluminum alloy-stainless steel clad metal plate P1 having two-layered structure (as shown in FIG. 7). The heat dissipation member 10 consists of a first surface 11, a second surface 12, a heat dissipating area 13, a joined area 14, a plurality of heat dissipation fins 15, and a joined plate 16. The first surface 11 and the second surface 12 are on two opposite sides of the heat dissipation member 10. As shown in FIG. 2, generally the bicycle disk brake pad is arranged vertically while in use. Now the heat dissipating area 13 is on an upper half of the heat dissipation member 10 while the joined area 14 is on a lower half of the heat dissipation member 10. It should be noted that the heat dissipating area 13 is not limited to be a half area of the heat dissipation member 10 although the heat dissipation area 13 is on the upper half of the heat dissipation member 10. A size of the heat dissipating area 13 relative to the joined area 14 is determined according to a size of final products. The plurality of heat dissipation fins 15 is disposed on the first surface 11 of the heat dissipating area 13 and extending toward a direction away from the heat dissipation member 10. A gap is formed between the two adjacent heat dissipation fins 15 for allowing air to move and heat to escape. The joined plate 16 is arranged at the joined area 14 and made of a stainless steel sheet ST of the aluminum alloy-stainless steel clad metal plate P1. An exposed surface of the joined plate 16 is a joined surface 161 which is flush with the second surface 12.

In a preferred embodiment, the heat dissipation fin 15 is formed by pressing forming of aluminum alloy located at the heat dissipating area 13 of the heat dissipation member 10. Thus the heat dissipation fins 15 are formed on the first surface 11 at the heat dissipating area 13 of the heat dissipation member 10 and having two forms. One looks like an arch, as shown in FIG. 2 and the other is columnar, as shown in FIG. 6.

The friction member 20 is fixed on the joined surface 161 of the joined plate 16 and composed of a substrate 21 and a friction pad 22 respectively made of stainless steel and composite friction material. In a preferred embodiment, the friction pad 22 is formed and attached to the substrate 21 by sintering of the composite friction material. It should be understood that the friction pad 22 and the substrate 21 are connected and integrated into one part. One lateral surface 211 of the substrate 21 without attached with the friction pad 22 is adhered to the joined surface 161 of the joined plate 16. In a preferred embodiment, a periphery S of the substrate 21 of the friction member 20 is welded to the joined surface 161 of the joined plate 16 by laser welding. It is understandable that the substrate 21 of the friction member 20 of the bicycle disk brake pad is made of stainless steel and used for supporting the friction pad 22 to prevent the friction member 20 from deformation at high temperature. Moreover, the substrate 21 of the friction member 20 is welded together with the joined surface 161 of the joined plate 16 by laser welding not only for providing reliable structural strength to prevent deformation of the disk brake pad at high temperature but also achieving the purpose of fast and automatic production.

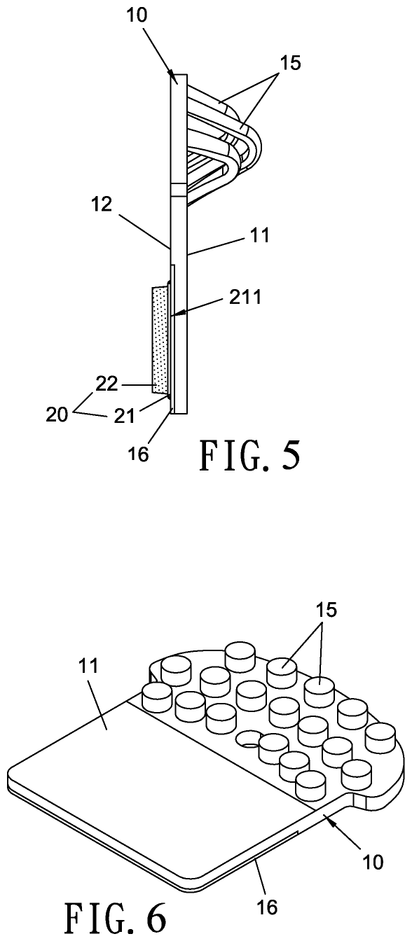

Refer to FIG. 4 and FIG. 5, another embodiment of a bicycle disk brake pad according to the present invention is provided. The joined surface 161 of the joined plate 16 is provided with blind holes 17. The lateral surface 211 of the substrate 21 of the friction member 20 without attached with the friction pad 22 is provided with protrusions 23 corresponding to the blind holes 17. The protrusions 23 are able to be coupled with the blind holes 17 correspondingly. In a preferred embodiment, a diameter of the blind hole 17 is tapered inward to form the blind hole 17 with a conical wall while a shape of the protrusion 23 is conical which matches the conical wall of the blind hole 17. In a preferred embodiment, there are two blind holes 17 and the number of the protrusions 23 is also two. During working period at which a friction occurs between the friction member 20 and the disk brake, a pushing force is generated in a direction parallel to a friction force acted on the friction member 20. By coupling between the protrusions 23 and the blind holes 17, a structural strength of the friction member 20 is increased to be resistant to the pushing force.

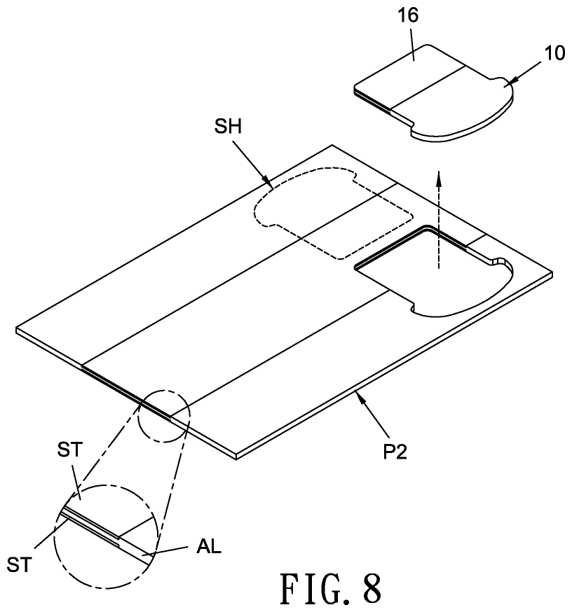

A method for making a bicycle disk brake pad according to the present invention includes the following steps.
a. preparing an aluminum alloy-stainless steel clad metal plate P1 which has a two-layered structure formed by a stainless steel sheet ST and an aluminum alloy sheet AL stacked over each other after surface cleaning and then treated by roll forming (as shown in FIG. 7). In a preferred embodiment, a thickness of the aluminum alloy-stainless steel clad metal plate P1 is 1.5-3.0 mm and a thickness of the stainless steel sheet ST is 0.2-1.0 mm while being applied to the bicycle disk brake pad. Refer to FIG. 8, in another preferred embodiment of the present invention, a three-layered stainless steel-aluminum alloy-stainless steel clad metal plate P2 is manufactured by the same roll forming technology. Then a heat dissipation member 10 is produced by the stainless steel-aluminum alloy-stainless steel clad metal plate P2. A first surface 11 and a second surface 12 on a joined area 14 of the heat dissipation member 10 are both stainless steel sheets ST so that structural strength of the heat dissipation member 10 is further enhanced.
b. preparing a friction member 20. A substrate 21 is made of stainless steel selected. A stainless steel plate is produced into the substrate 21 by pressing or laser cutting technique. A lateral surface of the substrate 21 is coated with composite friction material which forms a preset shape. Then the composite friction material is sintered to form a friction pad 22 which is attached to the substrate 21. After sintering, the friction pad 22 and the substrate 21 are integrated into one part. The substrate 21 made of stainless steel can withstand high temperature, without deformation during the sintering. In contrast to the stainless steel, the substrate 21 made of aluminum is unable to withstand the high temperature during the sintering.
c. using the aluminum alloy-stainless steel clad metal plate P1 to produce a heat dissipation member 10 which includes a first surface 11 and a second surface 12 arranged at two opposite sides of the heat dissipation member 10, a heat dissipating area 13, and a joined area 14. The first surface 11 of the heat dissipating area 13 is provided with a plurality of heat dissipation fins 15 extending toward a direction away from the heat dissipation member 10 and a gap is formed between the two adjacent heat dissipation fins 15. A joined plate 16 is disposed on the joined area 14 and formed by the stainless steel sheet ST of the aluminum alloy-stainless steel clad metal plate P1. An exposed surface of the joined plate 16 is a joined surface 161 which is at the same level with the second surface 12.
d. connecting the heat dissipation member 10 with the friction member 20. The substrate 21 of the friction member 20 and the joined plate 16 at the joined area 14 are welded by laser welding. In a preferred embodiment, a periphery S of the substrate 21 of the friction member 20 (as shown in FIG. 2) is welded to the joined surface 161 of the joined plate 16 on the joined area 14 by laser welding while the joined surface 161 of the joined plate 16 is made of stainless steel. The joined surface 161 of the joined plate 16 is provided with at least one blind hole 17 by pressing while a lateral surface of the substrate 21 of the friction member 20 without attached with the friction pad 22 is provided with at least one protrusion 23 corresponding to the blind hole 17 by pressing. The protrusion 23 and the blind hole 17 are coupled with each other correspondingly.

Refer to FIG. 7, in the step a. preparing an aluminum alloy-stainless steel clad metal plate P1 of a preferred embodiment, the step a. further includes a step of arranging the stainless steel sheet ST along a center line in a longitudinal direction D of the aluminum alloy sheet AL. A width W of the stainless steel sheet ST perpendicular to the longitudinal direction D is at least twice of a height h of the friction member 20 (as shown in FIG. 3, h means the height of the friction member 20 while the bicycle disk brake pad is vertically arranged in use) and sufficient to produce two pieces of the friction members 20. In the embodiment shown in FIG. 7, the prepared the aluminum alloy-stainless steel clad metal plate P1 is cut according to a shape SH of the heat dissipation member 10 to get a product of the heat dissipation member 10 quickly. As shown in FIG. 7, the aluminum alloy-stainless steel clad metal plate P1 is cut by pressing to obtain products of the heat dissipation member 10. In other embodiments, the aluminum alloy-stainless steel clad metal plate P1 can also be cut by laser cutting to get the products of the heat dissipation member 10.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

1. A bicycle disk brake pad comprising:
a heat dissipation member made of aluminum alloy-stainless steel clad metal plate which includes at least one aluminum alloy sheet and at least one stainless steel sheet attached to one lateral surface of the aluminum alloy sheet; the heat dissipation member having a first surface and second surface disposed on two opposite sides of the heat dissipation member correspondingly, a heat dissipating area, a joined area, a plurality of heat dissipation fins arranged at the first surface of the heat dissipating area and extending toward a direction away from the heat dissipation member, and a joined plate which is disposed on the joined area, made of the stainless steel sheet of the aluminum alloy-stainless steel clad metal plate, and provided with a joined surface formed by an exposed surface of the joined plate and at the same level with the second surface; and
a friction member fixed on the joined surface of the joined plate and provided with a substrate made of stainless steel and a friction pad formed by sintering of composite friction material and attached to the substrate; the friction pad and the substrate are connected and integrated into one part; one lateral surface of the substrate without attached with the friction pad is adhered to the joined surface of the joined plate while a periphery of the substrate of the friction member and the joined surface of the joined plate are welded together by laser welding.

2. The bicycle disk brake pad as claimed in claim 1, wherein the joined surface of the joined plate is provided with at least one blind hole while the lateral surface of the substrate of the friction member without attached with the friction pad is provided with at least one protrusion corresponding to the blind hole; the protrusion and the blind hole are coupled with each other correspondingly.

3. The bicycle disk brake pad as claimed in claim 2, wherein a diameter of the blind hole is tapered inward to form the blind hole with a conical wall while a shape of the protrusion is conical which matches the conical wall of the blind hole.

4. The bicycle disk brake pad as claimed in claim 2, wherein the joined surface of the joined plate is provided with the two blind holes and the two corresponding protrusions.

5. A method for making a bicycle disk brake pad comprising the steps of:
a. preparing an aluminum alloy-stainless steel clad metal plate which is formed by a stainless steel sheet and an aluminum alloy sheet stacked over each other after surface cleaning and then treated by roll forming;
b. preparing a friction member by using stainless steel selected to produce a substrate, coating composite friction material over a lateral surface of the substrate to form a preset shape, and then sintering the composite friction material to form a friction pad attached to the substrate;
c. using the aluminum alloy-stainless steel clad metal plate to produce a heat dissipation member which includes a first surface and a second surface arranged at two opposite sides of the heat dissipation member, a heat dissipating area, a joined area, a plurality of heat dissipation fins disposed on the first surface of the heat dissipation area and extending toward a direction away from the heat dissipation member, and a joined plate which is disposed on the joined area, made of the stainless steel sheet of the aluminum alloy-stainless steel clad metal plate, and provided with a joined surface formed by an exposed surface of the joined plate and located at the same level with the second surface; and
d. connecting the heat dissipation member with the friction member; connecting the substrate of the friction member and the joined plate at the joined area by laser welding.

6. The method as claimed in claim 5, wherein the joined surface of the joined plate is provided with at least one blind hole by pressing while a lateral surface of the substrate of the friction member without attached with the friction pad is provided with at least one protrusion corresponding to the blind hole by pressing; the protrusion and the blind hole are coupled with each other correspondingly.

7. The method as claimed in claim 6, wherein the blind hole with a conical wall is formed while the protrusion which is conical and matching the conical wall of the blind hole is formed.

8. The method as claimed in claim 5, wherein the stainless steel sheet is arranged along a center line in a longitudinal direction of the aluminum alloy sheet of the aluminum alloy-stainless steel clad metal plate; a width of the stainless steel sheet perpendicular to the longitudinal direction is at least twice of a height of the friction member.
